(19) United States
(12) Patent Application Publication
(10) Pub. No.: US 2025/0370948 A1
(43) Pub. Date: Dec. 4, 2025

(54) CONFIGURATION OF SWITCH DEVICES

(71) Applicant: Intel Corporation, Santa Clara, CA (US)

(72) Inventors: Marcos E. CARRANZA, Portland, OR (US); Karthik KUMAR, Chandler, AZ (US); Thomas WILLHALM, Sandhausen (DE); Cesar Ignacio MARTINEZ SPESSOT, Hillsboro, OR (US)

(21) Appl. No.: 19/299,716

(22) Filed: Aug. 14, 2025

(51) Int. Cl. G06F 13/40; G06F 9/54

(52) U.S. Cl. CPC G06F 13/4022; G06F 9/547; G06F 2213/0026

(57) ABSTRACT

Examples described herein relate to configuring a switch in an accelerator fabric to: monitor accesses to a memory region by one or more accelerators coupled to the accelerator fabric and report the accesses to the memory region to one or more specified accelerators coupled to the accelerator fabric. In some examples, the configuration includes a call to an application programing interface (API), a configuration file, a remote procedure call (RPC), or execution of a binary.

Accelerator pools are collections of hardware resources that are designed to increase a speed of data processing. Accelerator interconnects provide capability for high bandwidth accelerator-to-accelerator communication in multi-node deployments. Examples of accelerator interconnects include UALink Consortium Ultra Accelerator Link (UALink) and NVIDIA NVLink.

### BRIEF DESCRIPTION OF THE DRAWINGS

FIG. 1 depicts an example system.

FIG. 2 depicts an example system.

FIG. 3 depicts an example of operations.

FIG. 4 depicts an example of operations.

FIG. 5 depicts an example process.

FIG. 6 depicts an example computing system.

### DETAILED DESCRIPTION

Various examples provide a set of programmable memory configurations and memory access monitors to configure switches in accelerator fabrics to perform memory monitoring operations. For example, an Application Programming Interface (API) can set a region of memory addresses as read only. A call to the API or another API can cause a region of memory addresses to be written-to atomically (e.g., all or nothing). A call to the API or another API can monitor a region of memory addresses for reads or writes. The one or more APIs can assist with cache and memory coherence and can be utilized in multi-host use cases including multiple accelerator and graphics processing unit (GPU) systems. Other manners of configuring one or more switches in an accelerator fabric include use of a configuration file, a remote procedure call (RPC) to execute a process or binary on the one or more switches, or others.

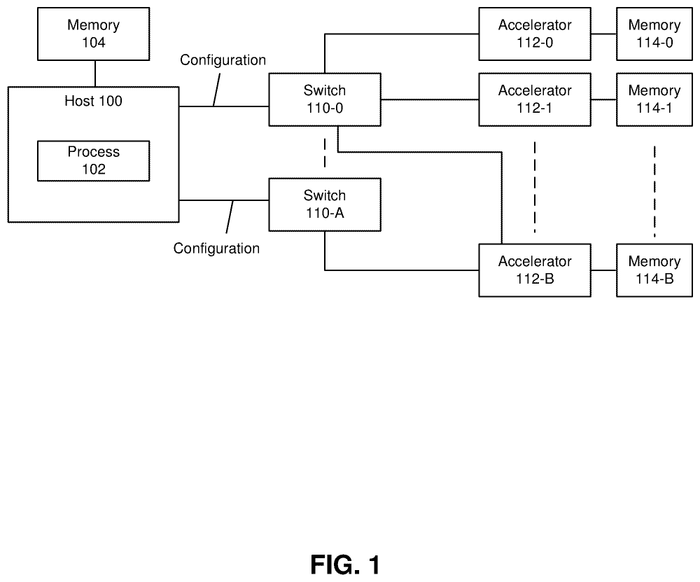

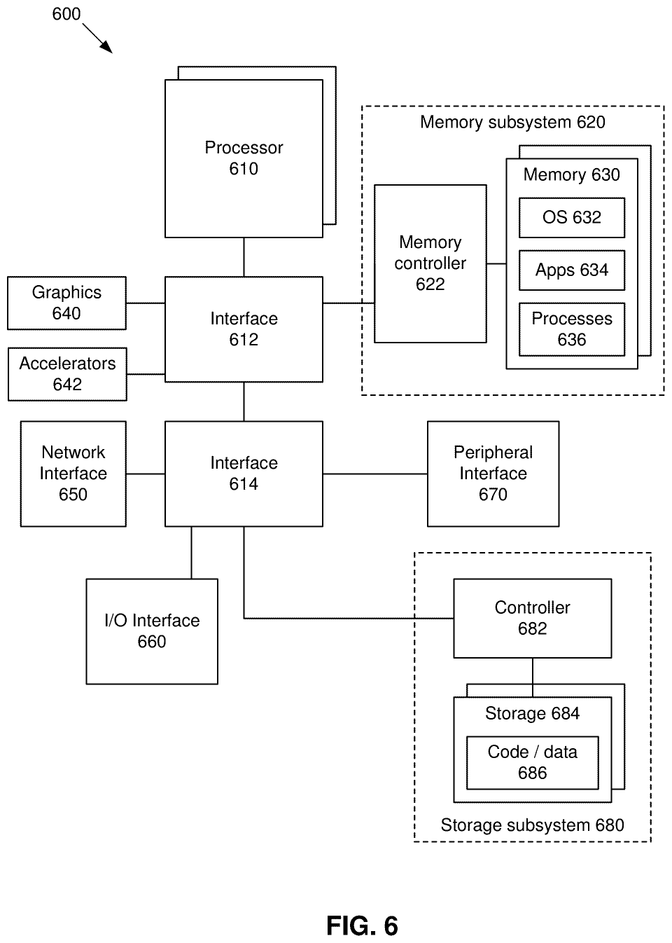

FIG. 1 depicts an example system. Host 100 can be embodied as a server or host system. In some examples, host 100 can be implemented as a system on chip (SoC) or one or more tiles. An SoC can include an integrated circuit that includes one or more of: one or more processors, memory interface, input/output (I/O) circuitry, storage interface, network interface, and other circuitry. A tile can include one or more processors and I/O circuitry formed in an SoC or connected by a circuit board. Various examples of circuitry and software that can be utilized by host 100 are described at least with respect to FIG. 6.

A processor of host 100 can execute processes 120. Processes 120 can include one or more of: application, process, thread, a virtual machine (VM), microVM, container, microservice, or other virtualized execution environment. Various examples of processes 120 can perform artificial intelligence (AI) training of models on datasets of text and code (e.g., large language models (LLMs)), inference operations, databases, or others. Processes 120 can access accelerators 112-0 to 112-B using multi-node communication primitives, such as NVIDIA Collective Communication Library (NCCL). NCCL provides routines such as all-gather, all-reduce, broadcast, reduce, reduce-scatter as well as point-to-point send and receive.

Host 100 can access accelerators 112-0 to 112-B and memories 114-0 to 114-B through one or more of switches 110-0 to 110-A of an accelerator fabric, where A is an integer. An accelerator (e.g., accelerator 112-0) can access an accelerator memory (e.g., accelerator memory 114-0 to accelerator memory 114-B) or host memory 104. Various communications technologies and protocols can be used to provide communication among host 100, memory 104, accelerators 112-0 to 112-B, or memories 114-0 to 114-B. Example technologies and protocols include Peripheral Component Interconnect Express (PCIe), Compute Express Link (CXL), AMD Infinity Fabric, AMD External Global Memory Interconnect (XGMI), ARM AMBA CHI Chip-to-Chip (C2C), UALink Consortium Ultra Accelerator Link (UALink), NVIDIA NVLink, or others.

In some examples, host 100 can communicate with accelerators 112-0 to 112-B via UALink links to and from switch (e.g., switch 110-0) allowing UALink Protocol Level Interface (UPLI) transactions to be routed between accelerators in different nodes or between accelerators in the same system node or memory devices in different nodes or between memory devices in the same system node. Various examples of accelerators 112-0 to 112-B can include one or more of: single or multi-core processor, graphics processing unit (GPU), application specific integrated circuit (ASIC), neural network processor (NNP), or field programmable gate array (FPGA).

In some examples, one or more of switches 110-0 to 110-A can operate as a non-coherent switch that supports memory-semantic operations and accessing memory resources (e.g., memory 104 or memories 114-0 to 114-B) but does not perform cache coherence across interconnected accelerators or processors. One or more of switch 110-0 to 110-A can perform load or store semantics and process 102 or other software or hardware can perform coherency to manage data consistency when multiple accelerators access shared memory.

In some examples, process 102 can call an API to configure one or more of switches 110-0 to 110-A to identify a region as read only, perform an atomic write operation, or track certain memory regions on a given node and notify a set of registered node identifiers based on the rule. Various examples of API formats are as follows.

| Example API with fields | Example command |
|---|---|
| RFO ADDR RANGE | Read for ownership (RFO) that requests |
| <ACCLR ID, RANGE | exclusive read only access to a range of |
| A, B>, <multicast | memory addresses between memory address A |
| list> | and memory address B in a memory device by |
| | one or more accelerators identified by ACCLR |
| | ID. The one or more accelerators can include |
| | one or more of accelerators 112-0 to 112-B. |
| | The memory device can include one or more |
| | of memory 104 or memory 114-0 to 114-B. |
| ATOMIC WRITE | Between ATOMIC WRITE <BEGIN> and |
| <BEGIN> | ATOMIC WRITE <END>, instructions that |
| ATOMIC WRITE | cause a write operation can be all or nothing in |
| <END> | terms of commit to memory addresses in a |
| | memory device. Accelerators or GPUs may |
| | not perform other writes to the memory |
| | addresses in the memory device until the |
| | atomic write is indicated as complete or fail. |
| | The one or more accelerators can include one |
| | or more of accelerators 112-0 to 112-B. The |
| | memory device can include one or more of |
| | memory 104 or memory 114-0 to 114-B. |
| ADDR RANGE | Monitoring reads/writes to address ranges |
| ARBITRATION | specified in RANGE A, B in a memory device |
| <ACCLR ID, RANGE | by one or more accelerators specified by |
| A, B> - TRACKERS | ACCLR ID. |
| (READ MULTICAST | READ MULTICAST list can specify one or |
| list, WRITE | more accelerators to inform of a read operation |
| MULTICAST list) | to the address ranges specified in RANGE A, B |
| | in a memory device. |
| | WRITE MULTICAST list can specify one or |
| | more accelerators to inform of a write |
| | operation to the address ranges specified in |
| | RANGE A, B in a memory device. |
| | The memory device can include one or more |
| | of memory 104 or memory 114-0 to 114-B. |
| | The one or more accelerators can include one |
| | or more of accelerators 112-0 to 112-B. |

Variations of APIs or configurations can be utilized. For example, modifications can include one or more of: fewer than the example fields can be utilized, more than the example fields can be utilized, a different order of fields can be utilized, fields from an API or configuration can be utilized in another API or configuration, conditions for performance of actions can be utilized, frequency of reporting can be utilized, time limit for performance of a configuration can be utilized, start time and/or end time for performance of a configuration can be utilized, or others.

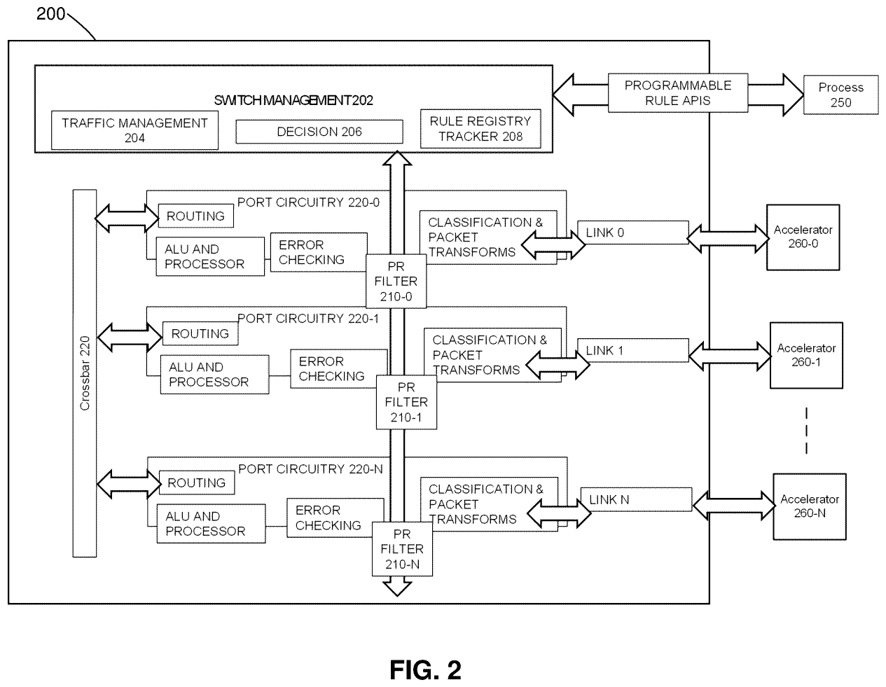

FIG. 2 depicts an example system. Processor-executed process 250 can call one or more APIs to configure operations of switch management 202 of switch 200. For example, one or more APIs can specify rules to register different trackers in switch 200. For example, rule registry tracker 208 can register rules that are tracked in switch 200. Tracker 208 can store rules and check for them against traffic that passes through programmable rule (PR) filters 210-0 to 210-N, where N is an integer. PR filters 210-0 to 210-N can read commands in traffic to determine whether the command indicate read, write, or administrative commands and associated memory addresses for read, write, or administrative commands.

Port circuitry 220-0 to 220-N can receive packets or transactions from respective accelerators 260-0 to 260-N from respective ingress ports. Port circuitry 220-0 to 220-N can perform routing of communications among accelerators 260-0 to 260-N through crossbar 220 via respective links 0 to N. Port circuitry 220-0 to 220-N can transmit packets or transactions to respective accelerators 260-0 to 260-N from respective egress ports. For packets received from an accelerator from an ingress port or prior to transmission of packets from an egress port to an accelerator, one or more of port circuitry 220-0 to 220 can perform classification and packet transformation, error checking and handling, packet processing by arithmetic logic unit (ALU) and processors, and routing of packets through crossbar 220 to another port circuitry. Crossbar 220 can route packets from ingress ports to egress ports based on source and destination information in packets according to a switch configuration. Various examples of port circuitry 220-0 to 220-N can operate in a manner consistent with protocols including Peripheral Component Interconnect Express (PCIe), Compute Express Link (CXL), AMD Infinity Fabric, AMD External Global Memory Interconnect (XGMI), ARM AMBA CHI Chip-to-Chip (C2C), UALink Consortium Ultra Accelerator Link (UALink), NVIDIA NVLink, or other protocols.

Decision circuitry 206 can determine if traffic in switch 200 meets a given rule. Decision circuitry 206 can (1) check if a given condition is met, and if a rule is to be activated in PR filters 210-0 to 210-N and (2) generate a notification specified by the rule and enqueue notifications in traffic management queues 204. For example, based on meeting a rule, decision circuitry 206 can submit read-notify signals and destination IDs to traffic management queues 204 for transmission of notifications to target nodes.

Traffic management queues 204 can enqueue tracking notifications and insert tracking notifications in the outgoing traffic from switch 200 to the destinations specified by the API or configuration, as described herein. For example, according to the API or configuration, tracking notifications can be sent to process 250 and/or one or more of accelerators 260-0 to 260-N.

Process 250 and/or one or more of accelerators 260-0 to 260-N can perform handling of notifications. For example, based on notification of a write to a read only region of memory addresses, a notified node or process can cause abort of work on data associated with the region of memory addresses until the write completes, shutdown processing data associated with the region of memory addresses, cause invalidation of data associated with the region of memory addresses stored in a cache or memory, or other operations.

For example, based on notification of a write to a read only region of memory addresses, a notified node, process, cache and home agent (CHA), caching agent (CA), or home agent (HA) can cause a consistency update to cause data written to the region of memory addresses to be propagated to be stored in other caches or memory that store the data. In connection with an access to a cache line by a core, a CA can attempt to determine whether another core or processor has access to the same cache line and corresponding memory address to determine cache coherency. Where another core or processor has access to the same cache line and corresponding memory address, the CA can provide data from its cache slice or obtain a copy of data from another core's cache. In some examples, a HA can attempt to achieve data coherency so that a processor receives a most recently modified copy of content of a cache line that is to be modified by the processor. In some examples, HA can attempt to provide data coherency among a cache device of a CPU socket, cache devices of one or more other CPU sockets, and one or more memory devices.

For example, based on notification of an atomic write operation failing, a notified node or process can retry the atomic write operation, cause the data written to be invalidated, or other operations.

For example, based on monitoring of reads or writes to address ranges, a notified node or process can determine that a memory region or switch is overloaded with reads or writes and can attempt to migrate less than an entirety or an entirety of the data to another memory or cache to reduce time to completion of data reads or writes from the address ranges, increase cache size to reduce time to completion of data reads or writes from the address ranges, allocate the address ranges to a different memory device or devices to reduce time to completion of data reads or writes from the address ranges, or other actions.

Circuitry of switch 200 can be implemented as part of a system on chip (SoC), System-In-Package (SiP), Multi-Chiplet Package (MCP), or others. An SiP encompasses multiple chiplets within a single package. An MP can include multiple chiplets for switch management 202, cross bar 220, port circuitry 220-0 to 220-N, or other circuitry. The chiplets can be mounted on a substrate (e.g., ceramic or laminate) that provides the electrical connections between chiplets. A package can encase one or more chiplets within a protective enclosure (e.g., plastic or ceramic) that provides mechanical support, thermal management, and electrical connections to other devices.

Although examples are described with respect to API calls, other examples of configuring switch 200 can include providing a configuration file, a Remote Procedure Call (RPC), RESTful API call, loading a binary for execution by switch 200, or other manners.

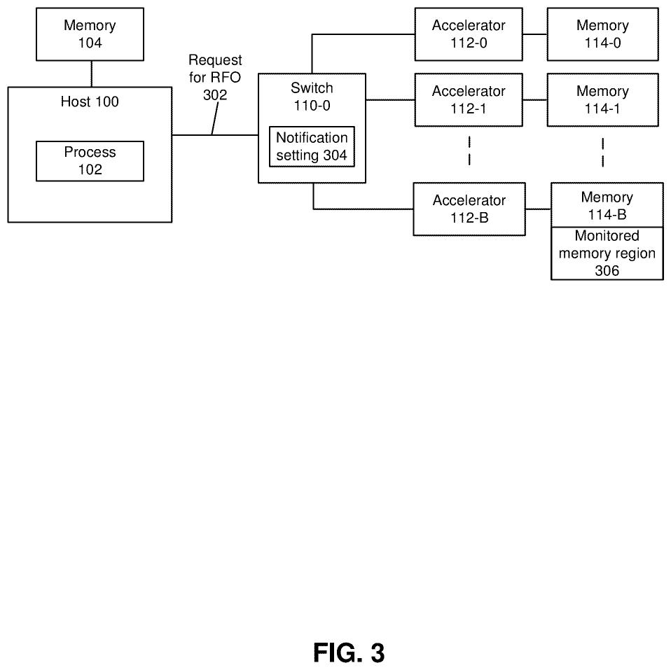

FIG. 3 depicts an example of operations. For example, rule ID 1 tracks for writes to an address range (0x1000 to 0x1fff) subject to read for ownership (RFO). Nodes for an operation to track can be 0, 1, 2, and 3 and can correspond to accelerators. For example, nodes 0, 1, 2, and 3 can correspond to accelerators that request data to be read only. Based on egress bandwidth (BW) of a configured switch to nodes that are to be notified (e.g., nodes 8, 9, 10, and 12), when the operation to notify condition is met, the switch can send a write notify signal to nodes 8, 9, 10, and 12. In some examples, BW value of X can be set to 0% to permit egress of time critical notifications, although other values can be used. For example, BW value of X can be set to 50% to permit egress of non-time critical notifications. Nodes 8, 9, 10, and 12 can correspond to accelerators that are permitted to update or access data in the address range.

| | | Node(s) for | Address for | | | |
|---|---|---|---|---|---|---|
| Rule | Operation | operation | operation | Node ids | Operation | |
| ID | to track | to track | to track | to notify | to notify | Condition |
| 1 | RFO | 0, 1, 2, 3 | 0x1000 to | 8, 9, 10, | WRITE- | SWITCH BW > |
| | ADDR | | 0x1fff | 12 | NOTIFY, | X %, where X is |
| | RANGE | | | | NODE ID, | specified by a |
| | | | | | ADDRESS | configuration. |

An example implementation of rule ID 1 can be as follows. Process 102 calls API 302 to request switch 110-0 to monitor a read only region of memory 306 in memory 114-B. Switch 110-0 can apply notification setting 304 to track whether there have been any requests to write to region of memory 306. For example, switch 110-0 can determine whether forwarded transactions request read, write, or are administrative operations and associated memory addresses that are to be read-from or written-to. In some examples, a format of forwarded transactions is consistent with a protocol utilized by a switch fabric or cross bar and can indicate an operation to be performed (e.g., read, write, or administrative). Switch 110-0 can notify accelerators 112-8, 112-9, 112-10, and 112-12 (corresponding to nodes 8, 9, 10, and 12) of a write operation to memory region 306. Various responsive actions are described herein.

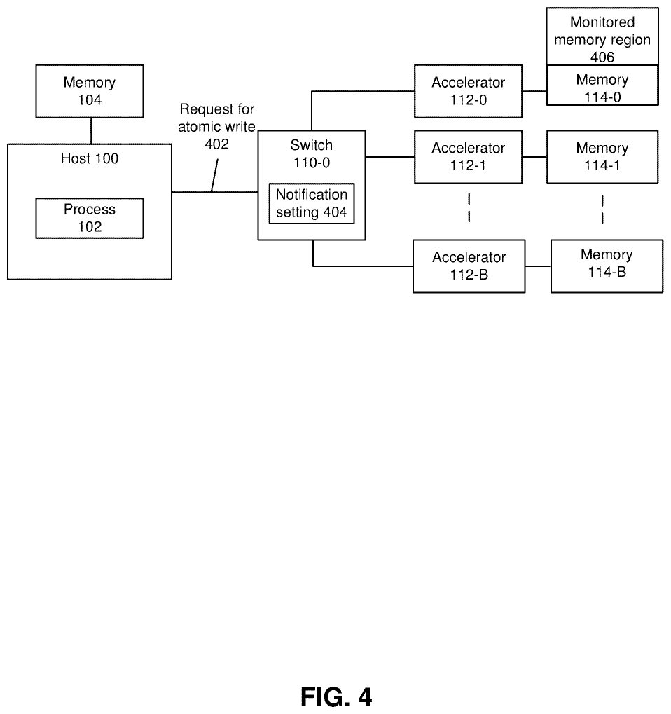

FIG. 4 depicts an example operation. For example, rule ID 2 tracks for reads to an address range (0x1000 to 0x1fff) subject to an atomic write operation. In the case of all or nothing atomic commits, rule ID 2 cause instructions between the atomic begin and end instructions to be tagged so that a switch notifies one or more accelerators of a read operation before a write operation is completed. Nodes for operations to track can be 0, 1, 2, and 3 and can correspond to accelerators. For example, nodes 0, 1, 2, and 3 can correspond to accelerators that request an atomic write operation. A notification may not be time critical and a condition to notification can be a utilized egress bandwidth (BW) of a configured switch to nodes that are to be notified (e.g., nodes 6, 7, 8, 9, 10, and 12) when BW is less than Y % capacity. When the operation to notify condition is met, the switch sends a write notify signal to nodes 6, 7, 8, 9, 10, and 12. For example, if egress bandwidth to nodes 6, 7, and 8 is more than Y % but egress bandwidth to nodes 9, 10, and 12 is less than Y %, then notification can take place to nodes 6, 7, and 8. When egress bandwidth to node 9 is more than Y %, then notification can take place to node 9. Similarly, when egress bandwidth to node 10 is more than Y %, then notification can take place to node 10. Similarly, when egress bandwidth to node 12 is more than Y %, then notification can take place to node 12.

| | | Node(s) for | Address for | | | |
|---|---|---|---|---|---|---|
| Rule | Operation | operation | operation | Node ids | Operation | |
| ID | to track | to track | to track | to notify | to notify | Condition |
| 2 | READ | 0, 1, 2, 3 | 0x1000 to | 6, 7, 8, 9, | READ- | SWITCH |
| | | | 0x1fff | 10, 12 | NOTIFY, | egress |
| | | | | | NODE ID, | bandwidth |
| | | | | | ADDRESS | (BW) > Y % |
| | | | | | | available |
| | | | | | | bandwidth, |
| | | | | | | Frequency |
| | | | | | | of reporting, |
| | | | | | | Level of |
| | | | | | | reporting |
| | | | | | | change |
| | | | | | | since last |
| | | | | | | report |

An example implementation of rule ID 2 can be as follows. Process 102 calls API 402 to request switch 110-0 to monitor an atomic write to region of memory 406 in memory 114-0. Switch 110-0 can apply notification setting 404 to track whether there have been any requests to read from region of memory 406 that is subject to an atomic write operation. For example, switch 110-0 can determine whether a read occurred before an end of an atomic write instruction. However, in some examples, region of memory 406 is not subject to an atomic write operation and can be memory addresses to track reads-from or writes-to. Based on notification setting 404, as notifications for rule ID 2 are not time critical and can be delayed based on available egress bandwidth to a node, when BW is more than Y % capacity to nodes 6, 7, 8, 9, 10, and 12, switch 110-0 can notify accelerators associated with nodes 6, 7, 8, 9, 10, and 12 of an attempted read to region 406. In some examples, Y can be 50%, however, other values of Y can be used.

For example, if egress bandwidth from the switch to nodes 6 and 7 is less than 50% but egress bandwidth from the switch to nodes 8, 9, 10, and 12 is more than 50%, the switch can notify nodes 8, 9, 10, and 12 but not notify nodes 6 and 7 until egress bandwidth to node 6 or 7 is more than 50%. For example, when egress bandwidth to node 6 is more than 50%, then notification can take place to node 6. For example, when egress bandwidth to node 7 is more than 50%, then notification can take place to node 7.

Example additional or alternative conditions to report notifications to a node can include a frequency of reporting to limit a frequency of notifications being sent to notified nodes or a level of change since last transmitted notification. For example, a condition can indicate reporting no more frequently than 1/A seconds, where A can be set by an API or configuration. For example, a condition can indicate a notification based on an increase in writes or reads to a memory region being more than B %, where B can be set by an API or configuration. Other examples of conditions can be used.

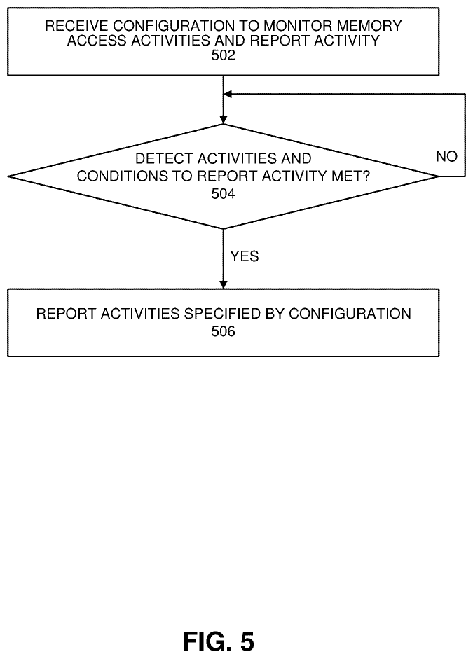

FIG. 5 depicts an example process. At 502, based on receipt of a configuration, a switch can be configured to monitor for specified activities. Specified activities can include designating read only regions of memory, specifying a write as atomic, or others. In some example, the same or different configuration can configure the switch to selectively report monitored activities based on available egress bandwidth. For example, monitored activities can be reported to specified accelerator nodes and/or a process that configured the switch. Monitored activities can include reporting a read only region has been written-to. Monitored activities can include reporting a memory region subject to an atomic write was read from. Monitored activities can include reporting a number of writes to or reads from a memory region. Other examples are described herein.

At 504, based on monitored activities being available to be reported and available egress bandwidth or other criteria meeting criteria of the configuration, the process can proceed to 506. Based on monitored activities not being available to be reported or available egress bandwidth other criteria not meeting criteria of the configuration, the process can repeat 504. Examples of other criteria can include a limit on frequency of reporting, a percent increase or decrease in number memory accesses since a last reporting, or others.

At 506, the monitored activities can be reported to the specified recipient node or process. For example, in response, the specified recipient node or process can perform one or more activities such as cache coherence operations, data invalidation, retry an atomic write operation, or others.

FIG. 6 depicts a system. In some examples, system 600 can be connected to a switch as a node or execute a process that configures a switch to notify one or more nodes of conditions being met, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. For example, accelerators 642 can include a load balancer accelerator or circuitry. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit (GPU), logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes a switch package that includes: circuitry configured to: based on a configuration, designate a memory region in one or more memory devices as read only and based on the configuration, track access to the memory region and notify a set of one or more accelerators based on access to the memory region.

Example 2 includes one or more examples, wherein the switch package includes: an interface to an ingress port, an interface to an egress port, a cross bar, and an interface to a memory.

Example 3 includes one or more examples, wherein: the configuration comprises one or more of a call to an application programing interface (API), a configuration file, a remote procedure call (RPC), or execution of a binary, the access to the memory region comprises a read operation, and based on the configuration and a first bandwidth utilization of the switch, the circuitry is to indicate read operations from the memory region to the one or more accelerators.

Example 4 includes one or more examples, wherein: the configuration comprises one or more of a call to an application programing interface (API), a configuration file, a remote procedure call (RPC), or execution of a binary, the access to the memory region comprises a write operation, and based on the configuration, the circuitry is to indicate the write operation to the memory region to the one or more accelerators.

Example 5 includes one or more examples, wherein: the circuitry is to: based on the configuration, cause an atomic write operation for one or more instructions to a second memory region and based on the configuration, track access to the second memory region and notify a second set of one or more accelerators based of access to the second memory region.

Example 6 includes one or more examples, wherein the access to the second memory region comprises a read operation prior to completion of the atomic write operation.

Example 7 includes one or more examples, wherein the configuration comprises: one or more of a call to an application programing interface (API), a configuration file, a remote procedure call (RPC), or execution of a binary and a request for read for ownership that specifies one or more of: a memory address range or one or more accelerators to notify of an access to the memory address range.

Example 8 includes one or more examples, wherein the configuration comprises: one or more of a call to an application programing interface (API), a configuration file, a remote procedure call (RPC), or execution of a binary and a request for atomic write operation by one or more instructions.

Example 9 includes one or more examples, wherein the configuration comprises: one or more of a call to an application programing interface (API), a configuration file, a remote procedure call (RPC), or execution of a binary and a request for address range arbitration that specifies one or more of: a memory address range, one or more accelerators to notify of a write operation, or one or more accelerators to notify to notify of a read operation.

Example 10 includes one or more examples, wherein the switch package is capable to be coupled to an accelerator fabric and the accelerator fabric is consistent with one or more of: Peripheral Component Interconnect Express (PCIe), Compute Express Link (CXL), AMD Infinity Fabric, AMD External Global Memory Interconnect (XGMI), ARM AMBA CHI Chip-to-Chip (C2C), UALink Consortium Ultra Accelerator Link (UALink), or NVIDIA NVLink.

Example 11 includes one or more examples, and includes at least one non-transitory computer-readable medium including instructions stored thereon, that when executed by one or more processors, cause the one or more processors to: based on a configuration, configure a switch in an accelerator fabric to: monitor accesses to a memory region by one or more accelerators coupled to the accelerator fabric and report the accesses to the memory region to one or more specified accelerators coupled to the accelerator fabric, wherein the configuration comprises a call to an application programing interface (API), a configuration file, a remote procedure call (RPC), or execution of a binary.

Example 12 includes one or more examples, wherein: the monitor accesses to the memory region by one or more accelerators coupled to the accelerator fabric comprises designate the memory region as read only and the report the accesses to the memory region to one or more specified accelerators coupled to the accelerator fabric comprises notify a set of one or more accelerators based on access to the memory region.

Example 13 includes one or more examples, wherein: the accesses to the memory region comprises read operations and the report the accesses to the memory region to one or more specified accelerators coupled to the accelerator fabric comprises indicate read operations from the memory region to the one or more accelerators.

Example 14 includes one or more examples, and includes instructions stored thereon, that when executed by one or more processors, cause the one or more processors to: based on the configuration, configure the switch to: cause an atomic write operation for one or more instructions to a second memory region and track access to the second memory region and notify a second set of one or more accelerators based of access to the second memory region.

Example 15 includes one or more examples, wherein the configuration comprises: a request for read for ownership that specifies one or more of: a memory address range or one or more accelerators to notify of an access to the memory address range.

Example 16 includes one or more examples, wherein the configuration comprises: a request for atomic write operation by one or more instructions.

Example 17 includes one or more examples, wherein the configuration comprises: a request for address range arbitration that specifies one or more of: a memory address range, one or more accelerators to notify of a write operation, or one or more accelerators to notify to notify of a read operation.

Example 18 includes one or more examples, and includes a method that includes: configuring a switch in an accelerator fabric to monitor accesses to a memory region and selectively notifying one or more nodes of accesses to the memory region based on a configuration from a process.

Example 19 includes one or more examples, wherein: the monitor accesses to the memory region comprises designate the memory region as read only and selectively notifying one or more nodes of accesses to the memory region comprises notifying a set of one or more accelerators based on access to the memory region.

Example 20 includes one or more examples, wherein: the accesses to the memory region comprises read operations and selectively notifying one or more nodes of accesses to the memory region comprises indicating read operations from the memory region to the one or more accelerators

1. An apparatus comprising:
a switch package comprising:
circuitry configured to:
based on a configuration, designate a memory region in one or more memory devices as read only and
based on the configuration, track access to the memory region and notify a set of one or more accelerators based on access to the memory region.

2. The apparatus of claim 1, wherein the switch package comprises:
an interface to an ingress port,
an interface to an egress port,
a cross bar, and
an interface to a memory.

3. The apparatus of claim 1, wherein:
the configuration comprises one or more of a call to an application programing interface (API), a configuration file, a remote procedure call (RPC), or execution of a binary,
the access to the memory region comprises a read operation, and
based on the configuration and a first bandwidth utilization of the switch, the circuitry is to indicate read operations from the memory region to the one or more accelerators.

4. The apparatus of claim 1, wherein:
the configuration comprises one or more of a call to an application programing interface (API), a configuration file, a remote procedure call (RPC), or execution of a binary,
the access to the memory region comprises a write operation, and
based on the configuration, the circuitry is to indicate the write operation to the memory region to the one or more accelerators.

5. The apparatus of claim 1, wherein:
the circuitry is to:
based on the configuration, cause an atomic write operation for one or more instructions to a second memory region and
based on the configuration, track access to the second memory region and notify a second set of one or more accelerators based of access to the second memory region.

6. The apparatus of claim 5, wherein the access to the second memory region comprises a read operation prior to completion of the atomic write operation.

7. The apparatus of claim 1, wherein the configuration comprises:
one or more of a call to an application programing interface (API), a configuration file, a remote procedure call (RPC), or execution of a binary and
a request for read for ownership that specifies one or more of: a memory address range or one or more accelerators to notify of an access to the memory address range.

8. The apparatus of claim 1, wherein the configuration comprises:
one or more of a call to an application programing interface (API), a configuration file, a remote procedure call (RPC), or execution of a binary and
a request for atomic write operation by one or more instructions.

9. The apparatus of claim 1, wherein the configuration comprises:
one or more of a call to an application programing interface (API), a configuration file, a remote procedure call (RPC), or execution of a binary and
a request for address range arbitration that specifies one or more of: a memory address range, one or more accelerators to notify of a write operation, or one or more accelerators to notify to notify of a read operation.

10. The apparatus of claim 1, wherein the switch package is capable of being coupled to an accelerator fabric and the accelerator fabric is consistent with one or more of: Peripheral Component Interconnect Express (PCIe), Compute Express Link (CXL), AMD Infinity Fabric, AMD External Global Memory Interconnect (XGMI), ARM AMBA CHI Chip-to-Chip (C2C), UALink Consortium Ultra Accelerator Link (UALink), or NVIDIA NVLink.

11. At least one non-transitory computer-readable medium comprising instructions stored thereon, that when executed by one or more processors, cause the one or more processors to:
based on a configuration, configure a switch in an accelerator fabric to:
monitor accesses to a memory region by one or more accelerators coupled to the accelerator fabric and
report the accesses to the memory region to one or more specified accelerators coupled to the accelerator fabric, wherein the configuration comprises a call to an application programing interface (API), a configuration file, a remote procedure call (RPC), or execution of a binary.

12. The non-transitory computer-readable medium of claim 11, wherein:
the monitor accesses to the memory region by one or more accelerators coupled to the accelerator fabric comprises designate the memory region as read only and
the report the accesses to the memory region to one or more specified accelerators coupled to the accelerator fabric comprises notify a set of one or more accelerators based on access to the memory region.

13. The non-transitory computer-readable medium of claim 12, wherein:
the accesses to the memory region comprises read operations and
the report the accesses to the memory region to one or more specified accelerators coupled to the accelerator fabric comprises indicate read operations from the memory region to the one or more accelerators.

14. The non-transitory computer-readable medium of claim 12, comprising instructions stored thereon, that when executed by one or more processors, cause the one or more processors to:
based on the configuration, configure the switch to:
cause an atomic write operation for one or more instructions to a second memory region and
track access to the second memory region and notify a second set of one or more accelerators based of access to the second memory region.

15. The non-transitory computer-readable medium of claim 12, wherein the configuration comprises:
a request for read for ownership that specifies one or more of: a memory address range or one or more accelerators to notify of an access to the memory address range.

16. The non-transitory computer-readable medium of claim 12, wherein the configuration comprises:
a request for atomic write operation by one or more instructions.

17. The non-transitory computer-readable medium of claim 12, wherein the configuration comprises:
a request for address range arbitration that specifies one or more of: a memory address range, one or more accelerators to notify of a write operation, or one or more accelerators to notify to notify of a read operation.

18. A method comprising:
configuring a switch in an accelerator fabric to monitor accesses to a memory region and selectively notifying one or more nodes of accesses to the memory region based on a configuration from a process.

19. The method of claim 18, wherein:
the monitor accesses to the memory region comprises designate the memory region as read only and
selectively notifying one or more nodes of accesses to the memory region comprises notifying a set of one or more accelerators based on access to the memory region.

20. The method of claim 18, wherein:
the accesses to the memory region comprises read operations and
selectively notifying one or more nodes of accesses to the memory region comprises indicating read operations from the memory region to the one or more accelerators.
